(19) United States
(12) Patent Application Publication
(10) Pub. No.: US 2025/0159351 A1
(43) Pub. Date: May 15, 2025

(54) DRILLER’S CABIN CAMERA SYSTEM

(71) Applicant: Nabors Drilling Technologies USA, Inc., Houston, TX (US)

(72) Inventors: Chandana KORITALA, Houston, TX (US); David HASLER, Houston, TX (US); Matt TIMMER, Fulshear, TX (US)

(21) Appl. No.: 18/939,652

(22) Filed: Nov. 7, 2024

Related U.S. Application Data
(60) Provisional application No. 63/597,764, filed on Nov. 10, 2023.

(51) Int. Cl. H04N 23/695; H04N 23/54; H04N 23/69

(52) U.S. Cl. CPC H04N 23/695; H04N 23/54; H04N 23/69

(57) ABSTRACT

A driller's cabin including a structure on a rig floor that separates an interior space from an exterior space. The interior space being configured to support an operator that controls one or more rig operations from within the interior space. The structure includes an outer surface and a window formed in the outer surface where light to passes through the window between the exterior space and the interior space and a camera system positioned in the interior space and aligned with the window, where the camera system includes a camera and a field of view of the camera views a first portion of the rig through the window.

### CROSS-REFERENCE TO RELATED APPLICATION(S)

This Application claims priority under 35 U.S.C. § 119 (c) to U.S. Provisional Patent Application No. 63/597,764, filed on Nov. 10, 2023, entitled “DRILLER'S CABIN CAMERA SYSTEM,” by Chandana KORITALA et al., which is assigned to the current assignee hereof and is incorporated herein by reference in its entirety.

### FIELD OF THE DISCLOSURE

The present invention relates, in general, to the field of drilling and processing of wells. More particularly, present embodiments relate to a system and method for monitoring a rig floor via a computer vision system.

### BACKGROUND

Existing options for placement of cameras on a rig floor for monitoring drilling activities are limited. Consistent placement of cameras on a rig can be difficult because each rig can be different and the field of view of the cameras are frequently (if not continuously) hampered, reduced, or eliminated by fluids and debris during rig operations that can obscure the camera lens. Depending upon placement of the camera, personnel may have to wait for downtime in the rig operations to clean, maintain, or adjust the camera. Additionally, depending upon placement of the camera, cabling to the camera for network and power connections can also be difficult. Therefore, improvements in computer vision systems are continually needed.

### SUMMARY

This summary is provided to introduce a selection of concepts that are further described below in the detailed description. This summary is not intended to identify indispensable features of the claimed subject matter, nor is it intended for use as an aid in limiting the scope of the claimed subject matter.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions. One general aspect includes a driller's cabin that supports conducting subterranean operations. The driller's cabin also includes a structure on a rig floor of a rig that separates an interior space from an exterior space, where the interior space is configured to support an operator that controls one or more rig operations from within the interior space, and where the structure may include an outer surface; a window formed in the outer surface, where the window allows light to pass through the window between the exterior space and the interior space; and a camera system positioned in the interior space and aligned with the window, where the camera system may include a camera, and where a field of view of the camera views a first portion of the rig through the window.

One general aspect includes a method for monitoring a rig floor during subterranean operations. The method also includes positioning a window in an outer surface of a driller's cabin; positioning a camera system in an interior of the driller's cabin; aligning the camera system with the window; viewing, via the camera system, a first portion of a rig through the window; capturing imagery, via a camera of the camera system, of the first portion of the rig; and receiving, via a network, the imagery at a rig controller. Other embodiments of this aspect include corresponding computer systems, apparatus, and computer programs recorded on one or more computer storage devices, each configured to perform the actions of the methods.

### BRIEF DESCRIPTION OF THE DRAWINGS

These and other features, aspects, and advantages of present embodiments will become better understood when the following detailed description is read with reference to the accompanying drawings in which like characters represent like parts throughout the drawings, wherein:

FIG. 1 is a representative simplified front view of a rig being utilized for a subterranean operation, in accordance with certain embodiments;

FIG. 2 is a representative perspective view of a driller's cabin on a rig floor of a rig, in accordance with certain embodiments;

FIG. 3 is a representative simplified partial cross-section view of computer vision system in a driller's cabin on a rig floor, in accordance with certain embodiments;

FIG. 4 is a representative perspective front view of a camera system in a driller's cabin on a rig floor, in accordance with certain embodiments;

FIG. 5 is a representative perspective rear view of a camera system in a driller's cabin on a rig floor, in accordance with certain embodiments;

FIG. 6 is a representative perspective front view of a camera system, in accordance with certain embodiments;

FIG. 7 is a representative perspective rear view of a camera system, in accordance with certain embodiments; and

FIG. 8 is a representative functional block diagram of a rig controller that can control rig equipment and perform methods of the current disclosure, in accordance with certain embodiments.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings.

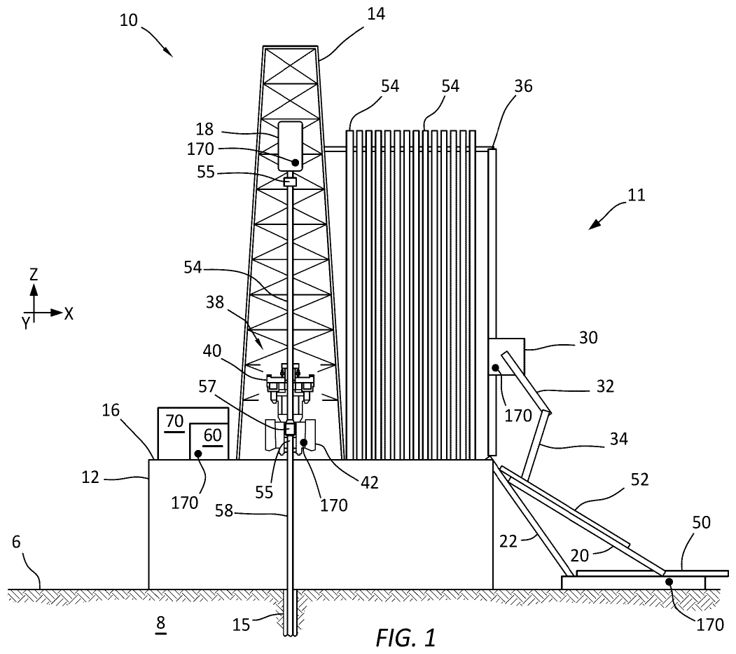

FIG. 1 is a representative simplified front view of a rig 10 being utilized for a subterranean operation (e.g., tripping in or out a tubular string 58 to or from a wellbore 15), in accordance with certain embodiments. Rig 10 can include platform 12 with a rig floor 16 and a derrick 14 extending up from the rig floor 16. The derrick 14 can provide support for hoisting the top drive 18 as needed to manipulate tubulars. A catwalk 20 and V-door ramp 22 can be used to transfer horizontally stored tubular segments 50 to the rig floor 16. A tubular segment 52 can be one of the horizontally stored tubular segments 50 that is being transferred to the rig floor 16 via the catwalk 20. A pipe handler 30 with articulating arms 32, 34 can be used to grab the tubular segment 52 from the catwalk 20 and transfer the tubular segment 52 to the top drive 18, the vertical storage 36, the wellbore 15, etc. However, it is not required that a pipe handler 30 be used on the rig 10. The top drive 18 can transfer tubulars directly between the catwalk 20 and the top drive 18 (e.g., using an elevator coupled to the top drive).

The tubular string 58 can extend into the wellbore 15, with the wellbore 15 extending through the surface 6 into the subterranean formation 8. When tripping the tubular string 58 into the wellbore 15, tubulars 54 are sequentially added to the tubular string 58 to extend the length of the tubular string 58 into the earthen formation 8. FIG. 1 shows a land-based rig. However, it should be understood that the principles of this disclosure are equally applicable to off-shore rigs where “off-shore” refers to a rig with water between the rig floor and the earth surface 6.

When tripping the tubular string 58 out of the wellbore 15, tubulars 54 are sequentially removed from the tubular string 58 to reduce the length of the tubular string 58 in the wellbore 15. The pipe handler 30 can be used to deliver the tubulars 54 to a well center on the rig floor 16 in a vertical orientation and hand the tubulars 54 off to an iron roughneck 38 or a top drive 18. The pipe handler 30 can also be used to remove the tubulars 54 from the well center in a vertical orientation and receive the tubulars 54 from the iron roughneck 38 or the top drive 18. The iron roughneck 38 can make a threaded connection between a tubular 54 being added and the tubular string 58. A spinner assembly 40 can engage a body of the tubular 54 to spin a pin end 57 of the tubular 54 into a threaded box end 55 of the tubular string 58, thereby threading the tubular 54 into the tubular string 58. The wrench assembly 42 can provide a desired torque to the threaded connection, thereby completing the connection. This process can be reversed when the tubulars 54 are being removed from the tubular string 58.

A rig controller 60 can be used to control the rig 10 operations including controlling various rig equipment, such as the pipe handler 30, the top drive 18 and the iron roughneck 38. The rig controller 60 can control the rig equipment autonomously (e.g., without periodic operator interaction,), semi-autonomously (e.g., with limited operator interaction such as initiating a subterranean operation, adjusting parameters during the operation, etc.), or manually (e.g., with the operator interactively controlling the rig equipment via remote control interfaces to perform the subterranean operation). A portion of the rig controller 60 can also be distributed around the rig 10, such as having a portion of the rig controller 60 in the pipe handler 30 and the iron roughneck 38 or at one or more various locations around the rig 10 or remote from the rig 10.

The rig controller 60 can receive sensor data from various sensors 170 positioned around rig 10 or the rig site 11. These sensors 170 can be located at any position on the rig 10 or at the rig site 11 (and downhole) as needed to collect data on rig operations and determine the state of the rig or the rig operations. The rig state or rig operation state can be used by the rig controller 60 to control manipulation of a camera system 100 to change a field of view of the camera system 100 to view various rig operations and portions of rig equipment being used to perform the operations.

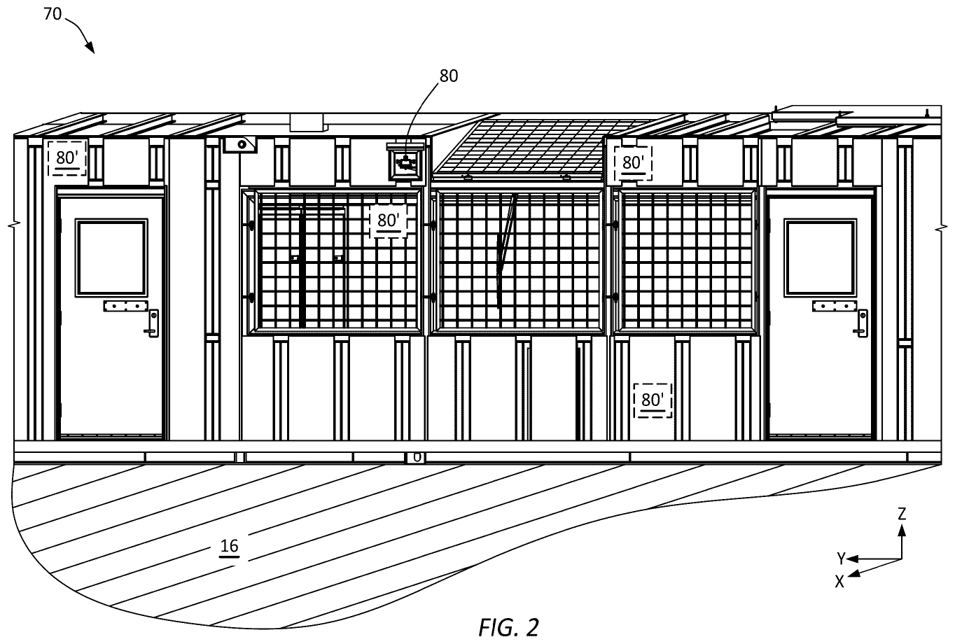

FIG. 2 is a representative perspective view of a driller's cabin 70 on a rig floor 16 of a rig 10, in accordance with certain embodiments. The Applicant has discovered unique benefits of installing camera(s) within the driller's cabin 70 (i.e., behind an outside surface of the driller's cabin). By positioning one or more camera systems 100 behind a transparent window at one or more locations 80, 80′ in the driller's cabin 70, 1) cabling to the camera system 100 can be simplified, 2) maintenance of the camera system 100 is greatly simplified, 3) the cameras of the camera systems are protected from environmental elements (e.g., direct sunlight, winds, rain, snow, ice, hail, saltwater spray, etc.), 4) the transparent window can be cleaned automatically (e.g., wipers, pressurized air bursts, etc.), and 5) the camera system 100 can provide a viewing perspective of the rig 10 that mimics the viewing perspective of rig operators in the driller's cabin 70, as well as other benefits.

The camera system 100 can be used to facilitate automation of positioning rig equipment (e.g., iron roughneck 38, pipe handler 30, catwalk 20, top drive 18, vertical storage 36, tubular string 58, slips, mud bucket, test equipment, etc.) as well as determining errors in positioning the rig equipment (e.g., stickup height errors of the tubular string 58, position errors of the iron roughneck 38, pipe handler 30, catwalk 20, top drive 18, vertical storage 36, tubular string 58, slips, mud bucket, test equipment, etc.).

Mimicking the viewing perspective of the operators allows the camera system 100 to be used for improving drillers productivity by displaying the rig activities as the operators would view them from the driller's cabin 70. This perspective can also be beneficial when implementing full rig automation.

The camera system 100 can be positioned at the location 80 behind a transparent window in the wall of the driller's cabin 70. Location 80 may be a preferred location based on the perspective view of the operators, but one or more camera systems 100 can be placed around the driller's cabin 70 at various locations 80′ but not limited to these locations 80, 80′ indicated in FIG. 2.

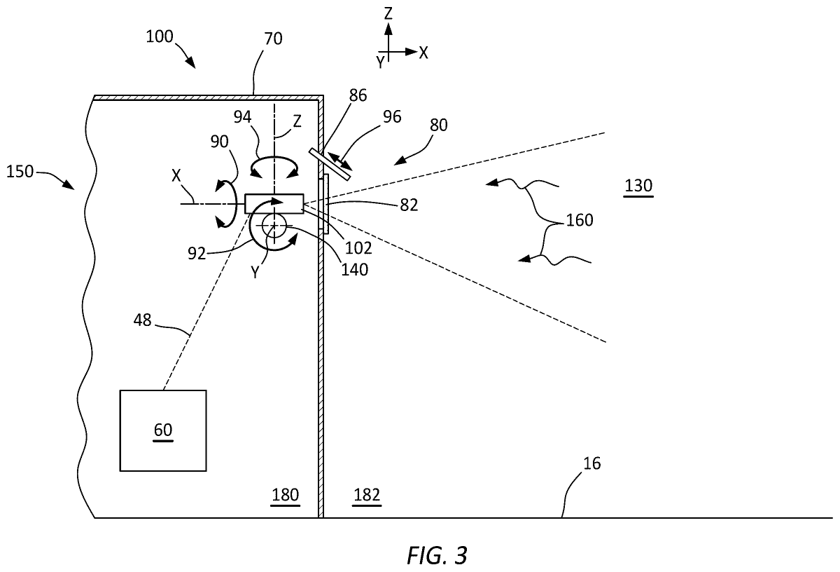

FIG. 3 is a representative simplified partial cross-section view of computer vision system 150 in a driller's cabin 70 on a rig floor 16, in accordance with certain embodiments. The computer vision system 150 can include the rig controller 60 communicatively coupled to a camera 102 of the camera system 100 via a network 48. The camera 102 can be one or more infrared cameras, two dimensional (2D) cameras, three dimensional (3D) cameras, closed circuit television (CCTV) cameras, radar cameras, visible light spectrum cameras, non-visible light spectrum cameras, light detection and ranging (LiDAR) cameras, etc.

The transparent window 82 can be designed to be transparent to the imagery signals 190 for the type of camera selected for the camera 102. Even if the transparent window 82 is not transparent to visible light it should be generally transparent for the imagery signals 190 for the type of camera selected for the camera 102. As used herein, “imagery signals” refers to the signals received by the camera 102 to produce the imagery that the camera 102 provides to the rig controller 60. For example, the imagery signals for LiDAR cameras can be laser signals, so the window can be generally transparent for laser signals. For example, the imagery signals for infrared cameras are infrared energy signals, so the window can be generally transparent for infrared energy signals.

The camera 102 can have a field of view 130 that extends from the camera 102 in an interior space 180 of the driller's cabin 70 through the transparent window 82 toward a portion of the rig 10 that is in an exterior space 182 external to the driller's cabin 70. The rig controller 60 (e.g., locally or remotely) can control the orientation of the camera 102 by controlling an actuator 140 to rotate the camera 102 (arrows 90, arrows 92, arrows 94) about any of the respective X, Y, and Z axes to direct the field of view 130 of the camera 102 toward a field of interest on the rig 10.

The field of interest can be determined by manually (e.g., via a joystick control) manipulating the camera 102 toward a desired portion of the rig 10. Alternatively, or in addition to, the field of interest can be determined by the rig controller 60 analyzing the well plan 163, receiving sensor data from the sensors 170 to determine a rig state, and determining what rig activity is being (or will be) performed, what rig equipment is involved in the rig activity, and controlling the actuator 140 to orient the camera 102 in the desired direction to place the field of interest in the field of view 130 of the camera 102.

For example, if the rig controller 60 determines from the well plan 163 and the sensors 170 that the rig state is tripping a tubular string into the wellbore, then the rig controller 60 can manipulate the camera 102 such that its field of view can include the well center to monitor the iron roughneck 38, the spinner assembly, the tubular 54, the top drive 18, the pipe handler 30, and operators, as well as other activities as these pieces of equipment and operators perform interactions with the tubular 54 and the tubular string 58 at the well center. The rig controller 60 can also manipulate the camera 102 such that the vertical storage area 36 is monitored for tubular management. The rig controller 60 can also manipulate the camera 102 to monitor the catwalk and tubulars 52 being supplied to the rig floor 16.

Additionally, the rig controller 60 can manipulate the camera 102 to view an area of dysfunction, such as when a dysfunction occurs (or is about to occur) and it is detected by the rig controller 60. Therefore, the rig controller 60 can manipulate the camera 102 to provide imagery of the equipment involved in the dysfunction (e.g., well center during a kick, vertical storage during a failure to secure the tubulars 54, failure of a piece of equipment, repair operations of the piece of equipment, etc.)

The camera 102 can include an aperture as well as a focus mechanism that can each be manually adjusted, as well as other parameters that can be adjusted. It may be preferred that these parameters be manually adjusted, e.g., to ensure that the camera 102 stays focused on the desired rig equipment or rig activity, without automatically focusing on another piece of equipment that is not of particular interest to the driller or rig operator. However, to manually focus or adjust the aperture settings, a rig operator may need to approach the camera 102 wherever it is positioned on the rig 10 to perform the desired adjustments. If the camera 102 is positioned in the Red Zone or in another area of rig activity, the rig operations may need to be halted to allow the rig operator to safely access the camera 102 to make parameters adjustments.

However, since the camera 102 of this disclosure is installed in the driller's cabin, an operator can access the camera 102 as needed without effecting operation of the rig 10 and without putting the operator in harm's way. The camera 102 can also be remotely controlled via a human machine interface (HMI) via a rig operator or via the rig controller 60.

The camera system 100 can include a retractable protrusion 86 that can be extended (arrows 96) to shield the transparent window 82 from the sun or from falling debris or precipitation, or retracted (arrows 96) to allow full view through the transparent window 82.

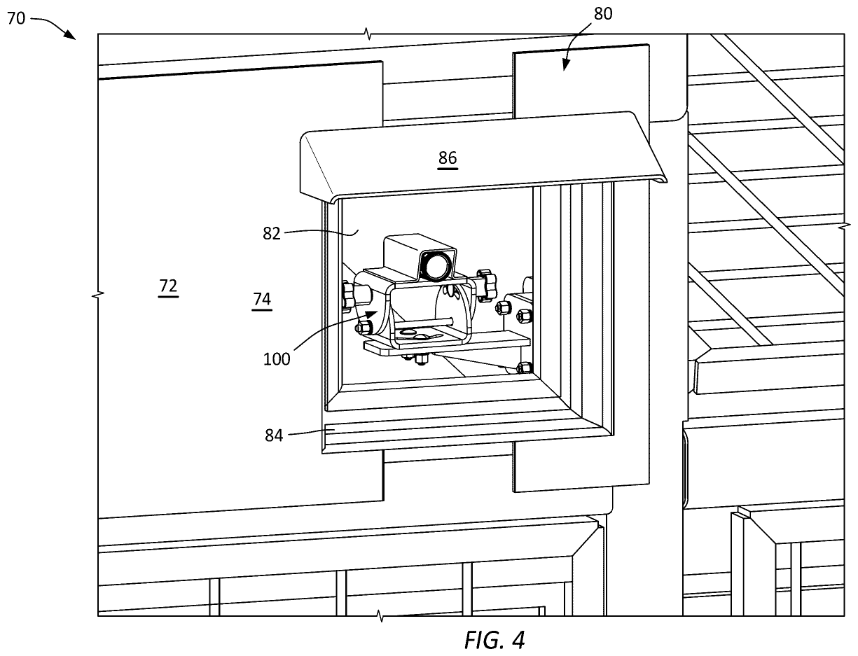

FIG. 4 is a representative perspective front view of a camera system 100 in a driller's cabin 70 on a rig floor 16, in accordance with certain embodiments. A transparent window 82 has been formed in an outer surface 74 of a structure 72 of the driller's cabin 70. Frame 84 can be used to support the transparent window 82 in the location 80. The camera system 100 can be placed in the interior space 180 of the driller's cabin 70 and aligned with the transparent window 82. The camera system 100 can be manipulated to change its field of view 130 through the transparent window 82. Protrusion 86 can be fixed, as shown, to the top side of the frame 84 to protect the window from falling debris or precipitation. The protrusion 86 can be selectively retractable to provide protection for the transparent window 82 when extended or provide full field of view through the transparent window 82 when retracted.

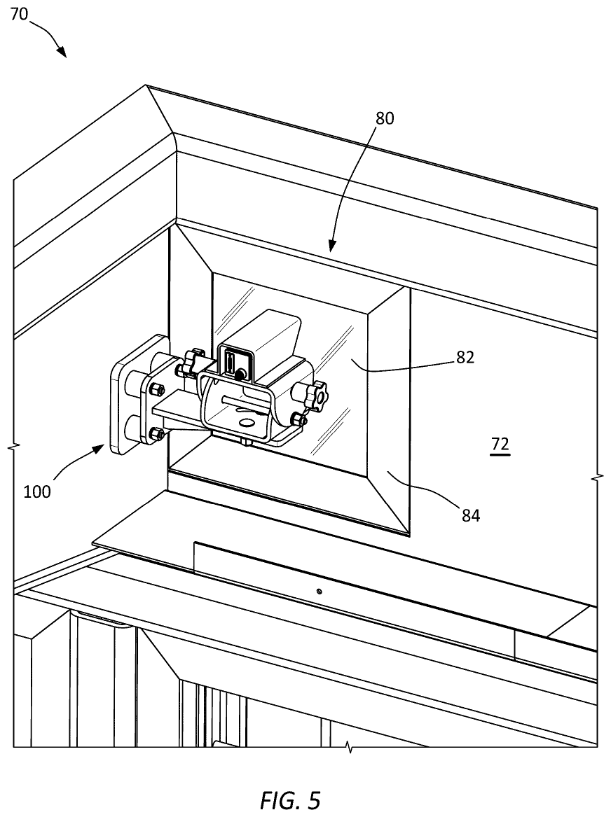

FIG. 5 is a representative perspective rear view of a camera system 100 in a driller's cabin 70 on a rig floor 16, in accordance with certain embodiments. In a non-limiting embodiment, the camera system 100 can be mounted to a support structure that positions the camera system 100 behind the transparent window 82 formed in the structure 72. It is preferable that the camera system 100 is accessible by operators from within the driller's cabin 70, such as for installation or maintenance.

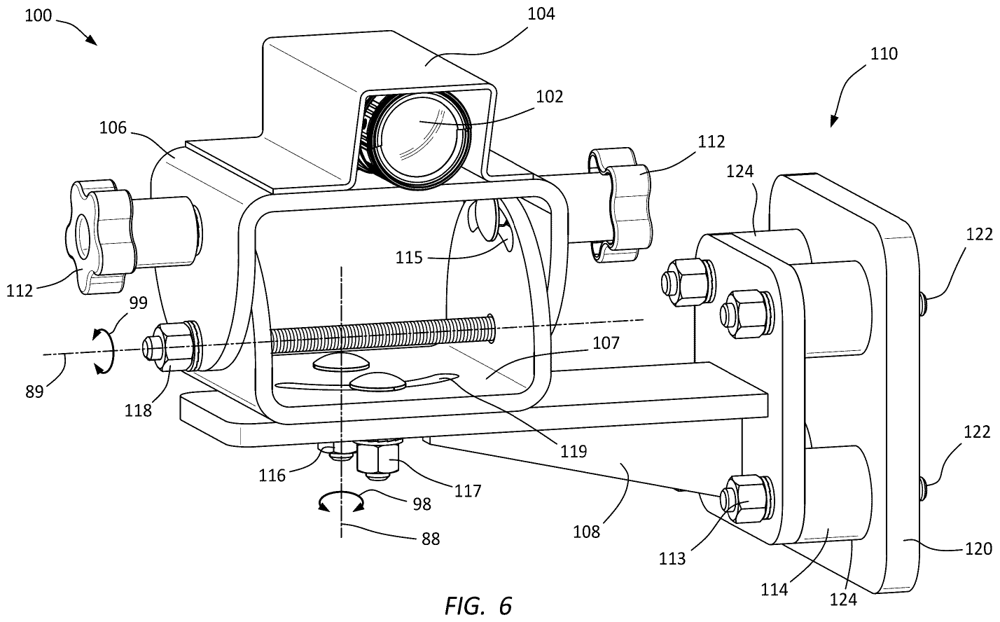

FIG. 6 is a representative perspective front view of a camera system 100, in accordance with certain embodiments. In a non-limiting embodiment, the camera system 100 can be mounted to a mounting bracket 110 that can be fastened to the structure 72 via fasteners 122. The fasteners 124 can be formed with threaded portions at both ends with a body 114 made from a resilient material (e.g., rubber, polymer, etc.) that can provide dampening of vibrations in the structure 72 of the driller's cabin 70. A base 120 can be attached to the structure 72 (e.g., via welding) and a bracket 108 of the mounting bracket 110 can be attached to the base 120 via the fasteners 122. Ends 113 of the fasteners 122 can be used to secure the bracket 108 to the base 120.

A bracket 107 can be attached to the bracket 108 via a fastener 116 and allowed to rotate (arrows 98) about the axis 88 (which can be a central axis of the fastener 116). A retainer 117 can extend through a hole in the bracket 108 and a curved slot 119 in the bracket 107. With the retainer 117 loosened, the bracket 107 can rotate (arrows 98) about the axis 88 to adjust a horizontal orientation of the camera 102. The bracket 107 can be rotated manually or automatically (e.g., as via an actuator) to adjust the horizontal orientation of the camera 102.

A bracket 106 can be attached to the bracket 107 via a fastener 118 and allowed to rotate (arrows 99) about the axis 89 (which can be a central axis of the fastener 118). A retainer 112 can extend through a hole on either side of the bracket 107 and a respective curved slot 115 in each side of the bracket 107. With the retainers 112 loosened, the bracket 106 can rotate (arrows 99) about the axis 89 to adjust a vertical orientation of the camera 102. The bracket 106 can be rotated manually or automatically (e.g., as via an actuator) to adjust the vertical orientation of the camera 102. An optional shroud 104 can be attached to the bracket 106 to further protect the camera 102 in the camera system 100.

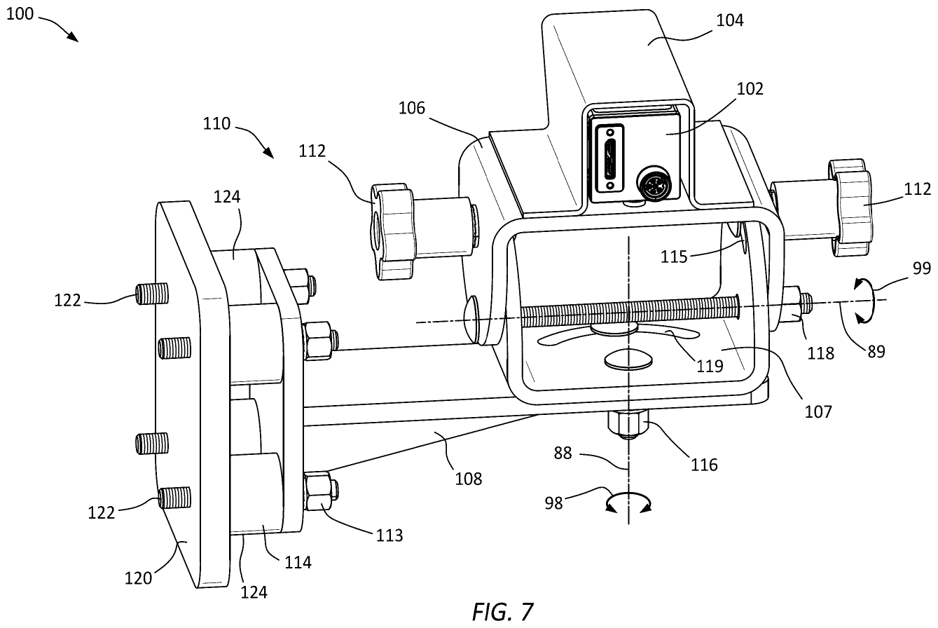

FIG. 7 is a representative perspective rear view of a camera system 100, in accordance with certain embodiments. The description above regarding FIG. 6 applies to the similar elements shown in FIG. 7. The camera 102 can be cabled to the rig controller 60 via the rear connectors which can communicatively couple the camera 102 to the rig controller 60 for transferring imagery to the rig controller 60 and commands and status data to the camera 102.

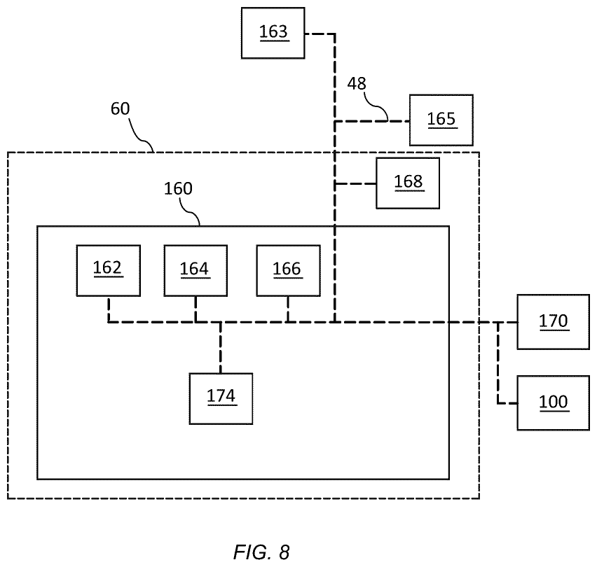

FIG. 8 is a representative functional block diagram of a rig controller 60 that can control rig equipment of the rig 10 and perform methods of the current disclosure, in accordance with certain embodiments. The rig controller 60 can include one or more local or remote processing units 160 that can be locally or remotely positioned relative to the rig 10 or downhole. Each processing unit 160 can include one or more processors 162 (e.g., microprocessors, programmable logic arrays, programmable logic devices, etc.), non-transitory memory storage devices 164, peripheral interface 166, human machine interface (HMI) device(s) 168, and possibly a remote telemetry interface 165 for internet communication or satellite network communication. The HMI devices 168 can include a touchscreen, a laptop, a desktop computer, a workstation, or wearables (e.g., smart phone, smart watch, tablet, etc.). These components of the rig controller 60 can be communicatively coupled together via one or more networks 48, which can be wired or wireless networks.

The processors 162 can be configured to read instructions from one or more non-transitory memory storage devices 164 and execute those instructions to perform any of the operations described in this disclosure. A peripheral interface 166 can be used by the rig controller 60 to receive sensor data from around the rig 10 or downhole which can collect data on the rig operations being performed. The peripheral interface 166 can also be used by the rig controller 60 to send commands to personnel or rig equipment to control rig operations during a subterranean operation. The rig controller 60 can receive a well plan 163 via the network 48 (or peripheral interface 166) and can determine a rig state based on the well plan 163 and data from the sensors 170.

The rig controller 60 can include a camera system 100 interface 174 for collecting and analyzing imagery from the camera system 100 based on the well plan 163 and the rig state. The imagery from the camera system 100 can be used by the rig controller 60 to determine whether the well plan 163 is being executed correctly or to assist the rig controller 60 is controlling rig equipment.

As used herein, the terms “comprises,” “comprising,” “includes,” “including,” “has,” “having,” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

The use of “a” or “an” is employed to describe elements and components described herein. This is done merely for convenience and to give a general sense of the scope of the invention. This description should be read to include one or at least one and the singular also includes the plural, or vice versa, unless it is clear that it is meant otherwise.

The use of the word “about”, “approximately”, “generally”, or “substantially” is intended to mean that a value of a parameter is close to a stated value or position. However, minor differences may prevent the values or positions from being exactly as stated. Thus, differences of up to ten percent (10%) for the value are reasonable differences from the ideal goal of exactly as described. A significant difference can be when the difference is greater than ten percent (10%).

As used herein, “tubular” refers to an elongated cylindrical tube and can include any of the tubulars manipulated around a rig, such as tubular segments, tubular stands, tubulars, and tubular string, but not limited to the tubulars shown in FIG. 1. Therefore, in this disclosure, “tubular” is synonymous with “tubular segment,” “tubular stand,” and “tubular string,” as well as “pipe,” “pipe segment,” “pipe stand,” “pipe string,” “casing string,” “coiled tubing”, or “wireline.”

It should be noted that the X-Y-Z coordinate axes are indicated in FIGS. 1-3, where the X-Y-Z coordinate axes are relative to the rig floor 16. The rig floor 16 forms an X-Y plane with the Z axis being substantially perpendicular with the rig floor 16. As used herein, “horizontal,” “horizontal position,” or “horizontal orientation” refers to a position that is substantially parallel with the X-Y plane. As used herein, “vertical,” “vertical position,” or “vertical orientation” refers to a position that is substantially perpendicular relative to the X-Y plane or substantially parallel with the Z axis.

### VARIOUS EMBODIMENTS

Embodiment 1. A driller's cabin that supports conducting subterranean operations comprising:
a structure on a rig floor of a rig that separates an interior space from an exterior space, wherein the interior space is configured to support an operator that controls one or more rig operations from within the interior space, and wherein the structure comprises an outer surface;
a window formed in the outer surface, wherein the window allows light to pass through the window between the exterior space and the interior space; and
a camera system positioned in the interior space and aligned with the window, wherein the camera system comprises a camera, and wherein a field of view of the camera views a first portion of the rig through the window.

Embodiment 2. The driller's cabin of embodiment 1, wherein the camera system further comprises an actuator, wherein the actuator manipulates the camera to orient the field of view of the camera to view a second portion of the rig through the window, and wherein at least a portion of the second portion of the rig includes a portion of the rig that is not included in the first portion of the rig.

Embodiment 3. The driller's cabin of embodiment 2, wherein the actuator rotates the camera about an x-axis, a y-axis, a z-axis, or combinations thereof.

Embodiment 4. The driller's cabin of embodiment 2, wherein the field of view of the camera mimics a field of view of the operator.

Embodiment 5. The driller's cabin of embodiment 2, wherein a rig controller is configured to manipulate, via the actuator, the camera such that the field of view of the camera views a portion of the rig floor that is used in an activity of a well plan.

Embodiment 6. The driller's cabin of embodiment 5, wherein the rig controller is configured to receive sensor data from one or more sensors about the rig or downhole, determine a rig state of the rig based on the sensor data, and manipulate the camera based on the rig state and the well plan.

Embodiment 7. The driller's cabin of embodiment 2, wherein a rig controller is configured to receive sensor data from one or more sensors about the rig or downhole.

Embodiment 8. The driller's cabin of embodiment 7, wherein a rig controller is configured to determine a rig state of the rig based on the sensor data and determine a rig operation based on the rig state and a well plan.

Embodiment 9. The driller's cabin of embodiment 8, wherein a rig controller is configured to manipulate the camera to position the field of view of the camera to view rig equipment involved in the rig operation.

Embodiment 10. The driller's cabin of embodiment 9, further comprising a network through which imagery of the rig equipment is transmitted to the rig controller for analysis.

Embodiment 11. The driller's cabin of embodiment 1, wherein the camera system further comprises a bracket, wherein adjustments of the bracket orients the camera to view a second portion of the rig through the window, and wherein at least a portion of the second portion of the rig includes a portion of the rig that is not included in the first portion of the rig.

Embodiment 12. The driller's cabin of embodiment 11, wherein the bracket is adjustable by operators in the driller's cabin to view the second portion.

Embodiment 13. A method for monitoring a rig floor during subterranean operations, the method comprising:
positioning a window in an outer surface of a driller's cabin;
positioning a camera system in an interior of the driller's cabin;
aligning the camera system with the window;
viewing, via the camera system, a first portion of a rig through the window;
capturing imagery, via a camera of the camera system, of the first portion of the rig; and
receiving, via a network, the imagery at a rig controller.

Embodiment 14. The method of embodiment 13, further comprising:
receiving, via the network, sensor data from one or more sensors about the rig or downhole;
receiving, via the network, a well plan at the rig controller; and
determining, via the rig controller, a rig state of the rig based on the sensor data and the well plan; and
determining, via the rig controller, an activity of the well plan being executed by rig equipment on the rig.

Embodiment 15. The method of embodiment 14, further comprising manipulating the camera, via the rig controller and based on the activity being executed, to direct a field of view of the camera towards the rig equipment.

Embodiment 16. The method of embodiment 15, further comprising determining, via the rig controller, actual operations of the rig equipment based on the imagery.

Embodiment 17. The method of embodiment 16, further comprising comparing the actual operations of the rig equipment to an expected operation of the rig equipment in the well plan.

Embodiment 18. The method of embodiment 14, wherein manipulating the camera further comprises actuating, via the rig controller, an actuator that manipulates the camera to change a field of view of the camera.

Embodiment 19. The method of embodiment 18, wherein manipulating the camera further comprises changing, via the rig controller, the field of view of the camera to be directed at the rig equipment of a first portion of the rig.

Embodiment 20. The method of embodiment 19, wherein manipulating the camera further comprises changing, via the rig controller, the field of view of the camera to be directed to a second portion of the rig.

Embodiment 21. The method of embodiment 20, wherein at least a portion of the second portion of the rig includes a portion of the rig that is not included in the first portion of the rig.

Embodiment 22. The method of embodiment 21, wherein changing the field of view of the camera further comprises changing the field of view of the camera based on detecting a second rig state or detecting a second activity of the well plan being executed.

While the present disclosure may be susceptible to various modifications and alternative forms, specific embodiments have been shown by way of example in the drawings and tables and have been described in detail herein. However, it should be understood that the embodiments are not intended to be limited to the particular forms disclosed. Rather, the disclosure is to cover all modifications, equivalents, and alternatives falling within the spirit and scope of the disclosure as defined by the following appended claims. Further, although individual embodiments are discussed herein, the disclosure is intended to cover all combinations of these embodiments.

What is claimed is:

1. A driller's cabin that supports conducting subterranean operations comprising:
a structure on a rig floor of a rig that separates an interior space from an exterior space, wherein the interior space is configured to support an operator that controls one or more rig operations from within the interior space, and wherein the structure comprises an outer surface;
a window disposed in the outer surface, wherein the window allows imagery signals to pass through the window between the exterior space and the interior space; and
a camera system positioned in the interior space and aligned with the window, wherein the camera system comprises a camera, and wherein a field of view of the camera views a first portion of the rig through the window.

2. The driller's cabin of claim 1, wherein the imagery signals comprise visible light spectrum signals, non-visible light spectrum signals, laser signals, infrared energy signals, radar signals, or a combination thereof.

3. The driller's cabin of claim 1, wherein the camera system further comprises an actuator, wherein the actuator manipulates the camera to orient the field of view of the camera to view a second portion of the rig through the window, and wherein at least a portion of the second portion of the rig includes a portion of the rig that is not included in the first portion of the rig.

4. The driller's cabin of claim 3, wherein the actuator rotates the camera about an x-axis, a y-axis, a z-axis, or combinations thereof.

5. The driller's cabin of claim 3, wherein a rig controller is configured to manipulate, via the actuator, the camera such that the field of view of the camera views a portion of the rig floor that is used in an activity of a well plan.

6. The driller's cabin of claim 3, wherein the field of view of the camera mimics a field of view of the operator.

7. The driller's cabin of claim 3, wherein a rig controller is configured to receive sensor data from one or more sensors about the rig or downhole.

8. The driller's cabin of claim 7, wherein a rig controller is configured to determine a rig state of the rig based on the sensor data and determine a rig operation based on the rig state and a well plan.

9. The driller's cabin of claim 8, wherein the rig controller is configured to manipulate the camera to position the field of view of the camera to view rig equipment involved in the rig operation.

10. The driller's cabin of claim 9, further comprising a network through which imagery of the rig equipment is transmitted to the rig controller for analysis.

11. The driller's cabin of claim 1, wherein the camera system further comprises a mounting bracket, wherein adjustments of the mounting bracket orients the camera to view a second portion of the rig through the window, and wherein at least a portion of the second portion of the rig includes a portion of the rig that is not included in the first portion of the rig.

12. The driller's cabin of claim 11, wherein the mounting bracket is adjustable by operators in the driller's cabin to view the second portion.

13. A method for monitoring a rig floor during subterranean operations, the method comprising:
positioning a window in an outer surface of a driller's cabin;
positioning a camera system in an interior of the driller's cabin;
aligning the camera system with the window;
viewing, via the camera system, a first portion of a rig through the window;
capturing imagery, via a camera of the camera system, of the first portion of the rig; and
receiving, via a network, the imagery at a rig controller.

14. The method of claim 13, further comprising:
receiving, via the network, sensor data from one or more sensors about the rig or downhole;
receiving, via the network, a well plan at the rig controller; and
determining, via the rig controller, a rig state of the rig based on the sensor data and the well plan; and
determining, via the rig controller, an activity of the well plan being executed by rig equipment on the rig.

15. The method of claim 14, further comprising manipulating the camera, via the rig controller, based on the activity being executed, and directing a field of view of the camera towards the rig equipment.

16. The method of claim 15, further comprising determining, via the rig controller, actual operations of the rig equipment based on the imagery; and comparing the actual operations of the rig equipment to an expected operation of the rig equipment in the well plan.

17. The method of claim 15, wherein manipulating the camera further comprises actuating, via the rig controller, an actuator that manipulates the camera to change a field of view of the camera.

18. The method of claim 17, wherein manipulating the camera further comprises changing, via the rig controller, the field of view of the camera to be directed at the rig equipment of a first portion of the rig.

19. The method of claim 18, wherein manipulating the camera further comprises changing, via the rig controller, the field of view of the camera to be directed to a second portion of the rig.

20. The method of claim 19, wherein changing the field of view of the camera further comprises changing the field of view of the camera based on detecting a second rig state or detecting a second activity of the well plan being executed.
